(19) United States
(12) Patent Application Publication
(10) Pub. No.: US 2026/0128647 A1
(43) Pub. Date: May 7, 2026

(54) MOTOR STRUCTURE AND FAN LAMP HAVING THE SAME

(71) Applicant: Hangzhou Juxing Intelligent Technology Co., Ltd., Hangzhou (CN)

(72) Inventor: Hongbing ZHENG, Hangzhou (CN)

(73) Assignee: Hangzhou Juxing Intelligent Technology Co., Ltd., Hangzhou (CN)

(21) Appl. No.: 19/007,577

(22) Filed: Jan. 2, 2025

(30) Foreign Application Priority Data
Nov. 1, 2024 (CN) 2024226776906

(51) Int. Cl. H02K 7/14; F21V 21/03; F21V 21/104; F21V 33/00; H02K 5/02

(52) U.S. Cl. CPC H02K 7/14; F21V 21/03; F21V 21/104; F21V 33/0096; H02K 5/02

(57) ABSTRACT

The motor structure comprises a motor main body and a first motor shell. The first motor shell is configured to fix the motor main body and be concentrically arranged with the motor main body; the first motor shell comprises multiple fan blade mounting structures integrally formed along the periphery of the first motor shell. The fan blade mounting structures are configured to be detachably connected to fan blades through connecting members. The first motor shell further comprises multiple limiting plate structures integrally formed along the periphery of the first motor shell, wherein there is one limiting plate structure located between any two adjacent fan blade mounting structures. When the first motor shell and the motor main body are connected, the limiting plate structures surround the motor main body, so as to ensure a relative position of the motor main body and the first motor shell.

### FIELD OF THE INVENTION

The present disclosure relates to the field of fans, in particular to a motor structure and a fan lamp having the same.

### BACKGROUND OF THE INVENTION

Fan lamps on the market generally use a structure where the fan blade mounting structure is installed separately from the motor main body. After performing alignment, the fan blade mounting structure of fan lamps is secured with the motor main body using locking screws. This often leads to complicated installation for users, and also increases packaging volume and manufacturing costs. Additionally, the structure used for positioning the fan blade mounting structure after fixation cannot ensure the precise alignment of the fan blade mounting structure and the motor main body, which may result in unwanted vibrations and noise.

### SUMMARY OF THE INVENTION

A motor structure and a fan lamp having the same is provided in the present disclosure, to avoid the fan blade mounting structure of the fan lamp being secured with the motor main body using locking screws, thus making sure the precise alignment of the fan blade mounting structure and the motor main body, as well as reducing unwanted vibrations and noise.

In a first aspect of the present disclosure, a motor structure and a fan lamp having the same are provided. A motor structure comprises a motor main body and a first motor shell. The first motor shell is configured to fix the motor main body and be concentrically arranged with the motor main body; the first motor shell comprises multiple fan blade mounting structures integrally formed along the periphery of the first motor shell. The fan blade mounting structures are configured to be detachably connected to fan blades through connecting members. The first motor shell further comprises multiple limiting plate structures integrally formed along the periphery of the first motor shell, wherein there is one limiting plate structure located between any two adjacent fan blade mounting structures. When the first motor shell and the motor main body are connected, the limiting plate structures surround the motor main body, so as to ensure a relative position of the motor main body and the first motor shell.

In an embodiment of the present disclosure, the limiting plate structures are arranged at a surface edge of the first motor shell and form a first angle with a surface plane of the first motor shell.

In an embodiment of the present disclosure, at least two limiting plate structures are provided.

In an embodiment of the present disclosure, the limiting plate structures and the fan blade mounting structures are alternatively distributed along the circumference of the first motor shell.

In an embodiment of the present disclosure, each of the fan blade mounting structures comprises a first plate structure and a second plate structure.

In an embodiment of the present disclosure, the first plate structure is arranged at a surface edge of the first motor shell, and the second plate structure is integrally connected to the first plate structure.

In an embodiment of the present disclosure, the second plate structure forms a second angle with the surface plane of the first motor shell.

In an embodiment of the present disclosure, at least one threaded hole is provided an outer edge of the second plate structure, and the threaded hole is configured to connect a fan blade to the second plate structure.

In an embodiment of the present disclosure, at least one thread hole is provided at a connection of the first plate structure and the surface edge of the first motor shell.

In an embodiment of the present disclosure, a counterbore hole is further provided on a surface plane of the first motor shell, and the counterbore hole is configured to connect the first motor shell to the motor main body and secure the motor main body using screws.

In a second aspect of the present disclosure, there is provided a fan lamp, and the fan lamp comprises the motor structure of any one of the first aspect, a ceiling mounting plate, a controller, a ceiling mounting shell, a second motor shell, a middle ring, fan blades, and a lamp housing.

As described above, the motor structure and the fan lamp having the same according to the present disclosure have the following advantages:

The integration structure of the fan blade mounting structure and the motor is provided in the motor structure and the fan lamp of the present disclosure, which ensures the relative positions of the fan blades and the motor shaft after the fan blades are assembled, so that unwanted vibration and noise caused by eccentricity can be avoided during operation. Meanwhile, the service life of the fan lamp is prolonged. The present disclosure not only prevents eccentric installation of the traditional fan lamp, but also improves the safety of the fan lamp in the operation process, additionally, a more efficient, environment-friendly, and less noisy experience in using the fan lamp is provided for users. Further, the structure of this fan lamp and its accessories are highly versatile, offering a wide range of applications.

### BRIEF DESCRIPTION OF DRAWINGS

FIG. 1 shows a top view of a 3D appearance structure of a fan lamp according to an embodiment of the present disclosure.

FIG. 2 shows a bottom view of a 3D appearance structure of the fan lamp according to an embodiment of the present disclosure.

FIG. 3 shows an exploded view of the fan lamp according to an embodiment of the present disclosure.

FIG. 4 shows a 3D structure diagram of a combination of a motor structure and fan blades according to an embodiment of the present disclosure.

FIG. 5 shows a schematic view of an integration of the motor structure and a first motor shell according to an embodiment of the present disclosure.

FIG. 6 shows an exploded view of the integration of the motor structure and the first motor shell according to an embodiment of the present disclosure.

FIG. 7 shows a structural side view of the motor structure and a ceiling mounting shell according to an embodiment of the present disclosure.

FIG. 8 shows a schematic structural view of a first motor shell according to an embodiment of the present disclosure.

### REFERENCE NUMERALS

110 Ceiling mounting plate
120 Controller
130 Ceiling mounting shell
140 Second motor shell
150 Middle ring
160 Motor structure
170 Fan blade
180 Lamp housing
200 Motor main body
300 First motor shell
310 Limiting plate structure
320 Counterbore hole
330 Fan blade mounting structure
340 First plate structure
350 Second plate structure

### DETAILED DESCRIPTION OF THE INVENTION

The present disclosure is further described below with reference to the drawings. The scope of protection of the present disclosure is not limited to the following.

The embodiments of the present disclosure are described below through specific examples, and a person skilled in the art can easily understand other advantages and effects of the present disclosure from the content disclosed in the specification. The present disclosure can also be implemented or applied through other different specific embodiments, and various details in the specification can also be modified or changed based on different viewpoints and applications without departing from the spirit of the present disclosure. It should be noted that, in the case of no conflict, the following embodiments and features in the embodiments may be combined.

It should be noted that the illustrations provided in the following embodiments are only intended to schematically demonstrate the basic concepts of the present disclosure. Therefore, the figures show only the components related to the present disclosure, rather than being drawn according to the actual number, shape, and size of the components in the implementation. In practice, the form, number, and proportions of the components may vary, and the layout of the components may also be more complex.

A motor structure and a fan lamp having the same are provided in the following embodiments of the present disclosure, to avoid the fan blade mounting structure of fan lamps being secured with the motor main body using locking screws, thus making sure the precise alignment of the fan blade mounting structure and the motor main body, as well as reducing unwanted vibrations and noise.

For the motor structure and the fan lamp in the embodiments of the present disclosure, an integration of the fan blade mounting structure and the motor is realized, which ensures the relative positions of the fan blades and the motor shaft after the fan blades are assembled, so that unwanted vibration and noise caused by eccentricity can be avoided during operation. Meanwhile, the service life of the fan lamp is prolonged. The present disclosure not only prevents eccentric installation of the traditional fan lamp, but also improves the safety of the fan lamp in the operation process, additionally, a more efficient, environment-friendly, and less noisy experience in using the fan lamp is provided for users.

The embodiments of the motor structure and the fan lamp having the same are described in detail below with reference to the drawings.

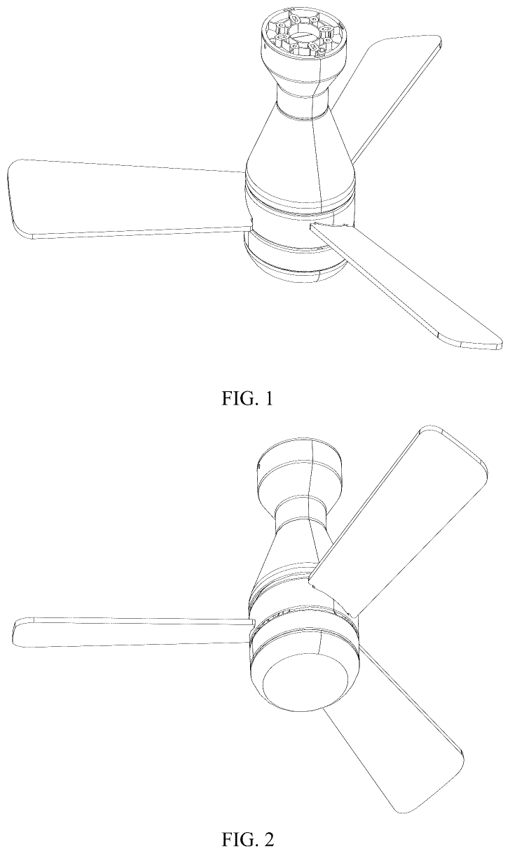

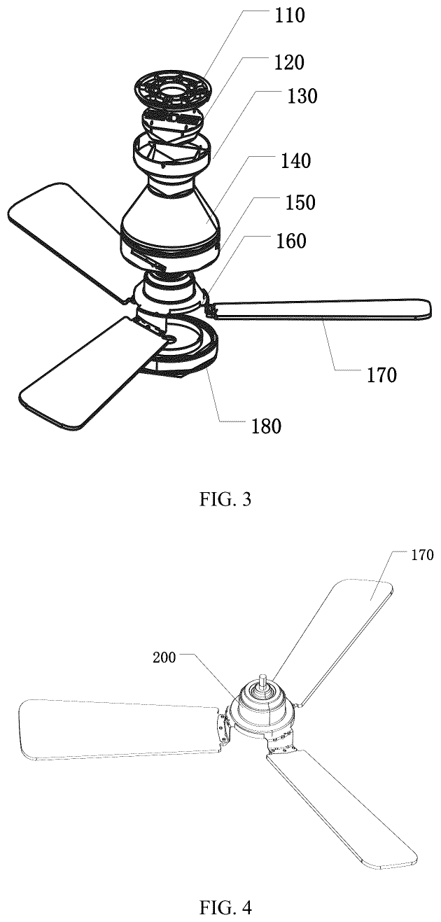

FIG. 1, FIG. 2, FIG. 3, and FIG. 4 respectively show a top view of a 3D appearance structure of a fan lamp according to an embodiment of the present disclosure, a bottom view of a 3D appearance structure of the fan lamp according to an embodiment of the present disclosure, an exploded view of the fan lamp according to an embodiment of the present disclosure, and a 3D structural diagram of a combination of a motor structure and fan blades according to an embodiment of the present disclosure. As shown in FIG. 1, FIG. 2, FIG. 3, and FIG. 4, the motor structure 160 comprises: a motor main body 200 and a first motor shell 300.

In an embodiment, the first motor shell 300 is configured to fix the motor main body 200 and is configured to be concentrically arranged with the motor main body 200. Multiple fan blade mounting structures 330 are integrally formed along the periphery of the first motor shell 300, and the fan blade mounting structures 330 may be detachably connected to the fan blades 170 through connecting members. Multiple limiting plate structures 310 are also integrally formed along the periphery of the first motor shell 300, and there is one limiting plate structure 310 located between any two adjacent fan blade mounting structures 330. When the first motor shell 300 and the motor main body 200 are connected, the limiting plate structures 310 surround the motor main body 200, so as to ensure the relative position of the motor main body 200 and the first motor shell 300.

Specifically, the fan lamp comprises: a ceiling mounting plate 110, a controller 120, a ceiling mounting shell 130, a second motor shell 140, a middle ring 150, a motor structure 160, fan blades 170, and a lamp housing 180.

Further, the fan lamp comprises a fan blade mounting structure 330, wherein the fan blade mounting structure 330 and the motor are integrated, and this integration structure of the fan blade mounting structure 330 and the motor is capable of matching and being adaptive with the fan blades. Therefore, installation of the fan blade mounting structure (three or more) is no longer needed, and the relative position between the fan blades and the shaft of the motor main body can be ensured after the fan blades are assembled, so that unnecessary vibrations and noise caused by position deviation of the fan lamp during the operation can be prevented. In addition, the high structural strength allows the deformation caused by collision or vibration to be avoided. Meanwhile, compared with a separable structure of the motor and fan blade mounting structure 330 commonly used in the traditional fan lamp, the number of parts is reduced due to the integration structure in the present disclosure, saving on manufacturing costs and the packaging space for the fan lamp products, while also enhancing the customer experience.

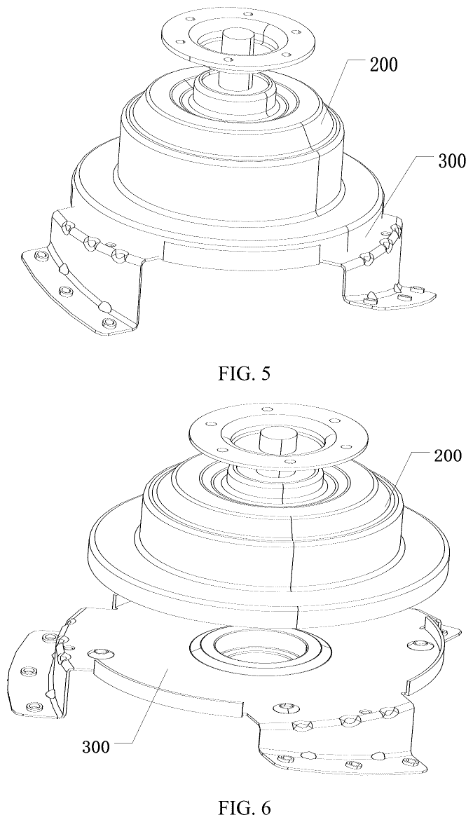

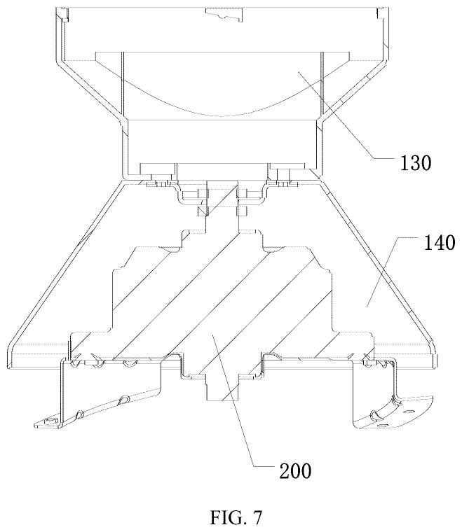

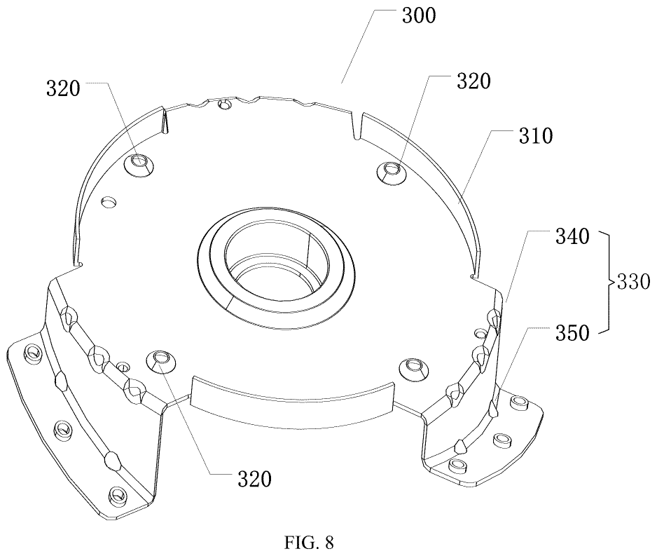

FIG. 5 to FIG. 8 respectively show a schematic view of an integration of the motor structure and a first motor shell according to an embodiment of the present disclosure, an exploded view of the integration of the motor structure and the first motor shell according to an embodiment of the present disclosure, a structural side view of the motor structure and a ceiling mounting shell to an embodiment of the present disclosure, and a schematic structural view of a first motor shell according to an embodiment of the present disclosure.

In an embodiment, the limiting plate structure 310 is arranged at the surface edge of the first motor shell 300 and forms a first angle with the surface plane of the first motor shell 300. Further, at least two limiting plate structures 310 are provided. The limiting plate structure 310 and the fan blade mounting structure 330 are distributed along the circumference of the first motor shell 300.

Specifically, the limiting plate structures 310 and the first motor shell 300 are integrated, wherein the limiting plate structures 310 are provided at the surface edge of the first motor shell 300 and form a first angle with the surface plane of the first motor shell 300. In the present disclosure, at least two limiting plate structures 310 are provided. Further, multiple counterbore holes 320 are provided on the surface plane of the first motor shell 300, and the counterbore holes 320 are configured to connect the first motor shell 300 to the motor main body 200 and secure the motor main body 200 using screws.

In the embodiment, three limiting plate structures 310 are provided, three fan blade mounting structures 330 are provided, and four counterbore holes 320 are provided. The first angle formed between each of the limiting plate structures and the surface plane of the first motor shell is 90°.

Specifically, the limiting plate structures 310 are arranged on the first motor shell 300, and three limiting plate structures are evenly distributed along the surface edge of the first motor shell 300. Each of the limiting plate structures is a bending plate and forms an angle of 90° with the surface plane of the first motor shell 300. The limiting plate structures 310 and the fan blade mounting structures 330 are alternatively arranged along the circumference of the first motor shell 300.

Meanwhile, four counterbore holes 320 are evenly distributed at an outer location on the surface plane of the first motor shell 300 in a circular pattern, i.e., four counterbore holes 320 have equal distances from the center of the surface plane of the first motor shell 300, ensuring that after installation, the first motor shell 300 is coaxial with the motor main body 200 and helping to maintain precise alignment. Additionally, the design of the counterbore holes 320 also contributes to the aesthetic appearance. The motor main body 200 is a brushless direct current motor, which has the effects of being efficient and quiet, thus improving user experiences.

In an embodiment, the first motor shell 300 comprises a fan blade mounting structure 330, and the fan blade mounting structure 330 comprises a first plate structure 340 and a second plate structure 350.

Specifically, the first plate structure 340 and the second plate structure 350 of the fan blade mounting structure 330 are bending plates, wherein the first plate structure 340 is arranged at the surface edge of the first motor shell 300. The first plate structure 340 and the second plate structure 350 are integrated into one piece. In the present disclosure, at least two fan blade mounting structures 330 are provided.

Each of the second plate structures 340 forms a second angle with the surface plane of the first motor shell 300. At least one threaded hole is arranged at the connection of each of the first plate structures 340 and the surface plane of the first motor shell 300, wherein these threaded holes are configured to connect the second motor shell 140 to the first motor shell 300. And at least one threaded hole is arranged on an outer location of each of the second plate structure 350, wherein these threaded holes are configured to connect the fan blades to the second plate structure 350, that is to say, the fan blades 170 can be connected to the fan blade mounting structure 330 of the first motor shell 300 through these threaded holes.

Please continue to refer to FIG. 8.

In an embodiment, three fan blade mounting structures 330 are provided, wherein each of the fan blade mounting structures 330 comprises one first plate structure 340 and one second plate structure 350. Three threaded holes are provided at the connection of the first plate structure 340 and the surface plane of the first motor shell 300, and three threaded holes are provided at the outer location of the second plate structure 350.

In an embodiment, three fan blade mounting structures 330 are evenly distributed along the circumference of the first motor shell 300. Three fan blade mounting structures 330 and three limiting plate structures 310 are alternatively arranged. The extension direction of the fan blade mounting structures 330 is opposite to the extension direction of the limiting plate structures 310. The fan blade mounting structures 330 can ensure the accurate location of the fan blades. Each of the fan blade mounting structures 330 comprises one first plate structure 340 and one second plate structure 350. Multiple threaded holes (for example, three threaded holes) are provided at the connection of the first plate structure 340 and the surface plane of the first motor shell 300, and multiple threaded holes (for example, three threaded holes) are provided at the outer location of the second plate structure 350, wherein the threaded holes on the second plate structure 350 are used for installation of the fan blades. Specifically, the fan blades 170 can be fastened and connected to the second plate structure 350 through connecting pieces (such as bolts and the like). Each of the second plate structures 350 forms the second angle with the surface plane of the first motor shell 300, wherein the second angle is preferably 13.1°.

In an embodiment, three limiting plate structures 310 (i.e. three bending plates) are arranged at the surface edge of the first motor shell 300, and four counterbore holes 320 are arranged on the surface plane of the first motor shell 300, so as to ensure that after installation, the first motor shell 300 is coaxial with the motor main body 200, helping to maintain precise alignment, as well as to contribute to the aesthetic appearance. The fan blade mounting structures 330 on the first motor shell 300 has an extension direction opposite to the limiting plate structures 310, and the fan blade mounting structures 330 can ensure the precise location of the fan blades 170. The second plate structure 340 of the fan blade mounting structure 330 forms an angle of 13.1° with the surface plane of the first motor shell 300, which facilitates generating a maximum airflow under the same power, with a larger air output range as well. Three reinforcing ribs are provided at the connection of the surface plane of the first motor shell 300 and the first plate structure 340 and the connection of the first plate structure 340 and the second plate structure 350, respectively, to improve the overall structural strength of the fan blade mounting structure 330 and the stability of these two connections. Each second plate structure 350 is provided with three threaded holes for the installation of the fan blades 170. After the fan blades 170 and the motor are assembled, the relative location between the fan blades 170 and the motor shaft is ensured, which allows smooth fan blade rotation and avoids unwanted vibrations and noise.

In an embodiment, the controller 120 uses a dual-connection mode, with separate control for the light source board and the motor. During use, the fan lamp's light switch, color-changing functions, and other settings can be realized via the remote control, and airflow can be regulated via the fan blade speed.

In an embodiment, the fan blades 170, prepared from a clamping process, are fixed to the second plate structure 340 of the first motor shell 300 using screws, to ensure the strength of the fan lamp and its aesthetic appearance.

In an embodiment, a ceiling mounting plate 110 is positioned at an upper end of the controller 120, and the ceiling mounting plate 110 needs to meet the weight-bearing requirement.

In an embodiment, a middle ring 150 is positioned on the outer edge of the first motor shell 300. Slots, which allow the fan blades 170 to pass through, are provided on the middle ring 150. The size of these slots matches the size and angle of the fan blades, and the angle of these slots matches that of the installed fan blades.

In an embodiment, the lamp housing 180 is made of a PC material, and a shell of the motor main body 200 is made of steel, to ensure the strength and meet the weight-bearing requirement.

The installation process of a fan lamp is described below.

Firstly, connecting the middle ring 150 and the second motor shell 140 using screws to the motor structure 160 to form a main portion of a fan lamp. Then, fixing the ceiling mounting shell 130 onto this main portion. Allowing the fan blades 170 to pass through the slots of the middle ring 150 and securing the fan blades 170 with screws to the motor structure 160. Next, fastening the lamp housing 180 onto a lower part of the motor structure 160 by rotating the lamp housing 180. Fixing the controller 120 inside the ceiling mounting shell 130, and ensuring it is electrically connected to both the lamp housing 180 and the motor structure 160 to provide power to both. Securing the ceiling mounting plate 110 to the ceiling and connecting the null line and power line to the controller 120. Finally, fastening a lamp to complete the installation of the fan lamp.

In the present disclosure, the fan blade mounting structure and the motor are integrated, which offers high structural strength and ensures precise location, allowing smooth fan blade rotation and avoiding unwanted vibrations and noise.

In conclusion, an integration structure of the fan blade mounting structure and the motor is provided in the motor structure and the fan lamp of the present disclosure, which ensures the relative positions of the fan blades and the motor shaft after the fan blades are assembled, so that unwanted vibration and noise caused by eccentricity can be avoided during operation. Meanwhile, the service life of the fan lamp is prolonged. The present disclosure not only prevents eccentric installation of the traditional fan lamp, but also improves the safety of the fan lamp in the operation process, additionally, a more efficient, environment-friendly, and less noisy experience in using the fan lamp is provided for users. Further, the structure of this fan lamp and its accessories are highly versatile, with a wide range of applications, offering significant practical value.

The above-mentioned embodiments only illustrate the principles and effects of the present disclosure, and are not intended to limit the present disclosure. Those skilled in the art can modify or change the above embodiments without departing from the spirit and scope of the present disclosure. Therefore, all equivalent modifications or changes made by a person of ordinary skill in the art without departing from the spirit and technical idea disclosed in the present disclosure still should be covered by the claims of the present disclosure.

1. A motor structure, comprising a motor main body and a first motor shell;
wherein the first motor shell is configured to fix the motor main body and be concentrically arranged with the motor main body;
the first motor shell comprises multiple fan blade mounting structures integrally formed along the periphery of the first motor shell;
the fan blade mounting structures are configured to detachably connect to fan blades through connecting members;
the first motor shell further comprises multiple limiting plate structures integrally formed along the periphery of the first motor shell, wherein there is one limiting plate structure located between any two adjacent fan blade mounting structures;
when the first motor shell and the motor main body are connected, the limiting plate structures surround the motor main body, so as to ensure a relative position of the motor main body and the first motor shell.

2. The motor structure according to claim 1, wherein the limiting plate structures are arranged at a surface edge of the first motor shell and form a first angle with a surface plane of the first motor shell.

3. The motor structure according to claim 2, wherein at least two limiting plate structures are provided.

4. The motor structure according to claim 1, wherein the limiting plate structures and the fan blade mounting structures are alternatively distributed along the circumference of the first motor shell.

5. The motor structure according to claim 1, wherein each of the fan blade mounting structures comprises a first plate structure and a second plate structure.

6. The motor structure according to claim 1, wherein the first plate structure is arranged at a surface edge of the first motor shell;
and the second plate structure is integrally connected to the first plate structure.

7. The motor structure according to claim 6, wherein the second plate structure forms a second angle with the surface plane of the first motor shell.

8. The motor structure according to claim 6, wherein at least one threaded hole is provided an outer edge of the second plate structure;
and the threaded hole is configured to connect a fan blade to the second plate structure.

9. The motor structure according to claim 6, wherein at least one thread hole is provided at a connection of the first plate structure and the surface edge of the first motor shell.

10. The motor structure according to claim 1, wherein a counterbore hole is further provided on a surface plane of the first motor shell;
and the counterbore hole is configured to connect the first motor shell to the motor main body and secure the motor main body.

11. A fan lamp, comprising the motor structure of claim 1, a ceiling mounting plate, a controller, a ceiling mounting shell, a second motor shell, a middle ring, fan blades, and a lamp housing.
